(19) United States
(12) Patent Application Publication
(10) Pub. No.: US 2025/0210675 A1
(43) Pub. Date: Jun. 26, 2025

(54) INTEGRATED FUEL CELL AND ABSORPTION CHILLER SYSTEM AND METHODS OF OPERATING THE SAME

(71) Applicant: BLOOM ENERGY CORPORATION, San Jose, CA (US)

(72) Inventors: Rueben M. KEMPTON, San Jose, CA (US); Chad PEARSON, Kirkland, WA (US); Lorenzo PENNA, San Jose, CA (US); Joseph TAVI, Danville, CA (US); Ravi PRASHER, Danville, CA (US); Prateek VYAS, Bangalore (IN)

(21) Appl. No.: 18/968,254

(22) Filed: Dec. 4, 2024

Related U.S. Application Data
(60) Provisional application No. 63/612,781, filed on Dec. 20, 2023.

(51) Int. Cl. H01M 8/04007; H01M 8/04119; H01M 8/12; H01M 8/1246; H01M 8/2425; H01M 8/2484

(52) U.S. Cl. CPC H01M 8/04059; H01M 8/04164; H01M 8/1246; H01M 8/2425; H01M 8/2484; H01M 2008/1293; H01M 2250/10

(57) ABSTRACT

An integrated fuel cell and absorption chiller system includes a fuel cell system configured to generate electrical power and waste heat, and an absorption chiller operatively coupled to the fuel cell system. The absorption chiller is configured to provide cooling using the waste heat generated by the fuel cell system.

### FIELD

Aspects of the present invention relate to fuel cell systems and methods of operating thereof, and more particularly, to an integrated fuel cell and absorption chiller system.

### BACKGROUND

Fuel cells, such as solid oxide fuel cells, are electrochemical devices which can convert energy stored in fuels to electrical energy with high efficiencies. High temperature fuel cells include solid oxide and molten carbonate fuel cells. These fuel cells may operate using hydrogen and/or hydrocarbon fuels. There are classes of fuel cells, such as solid oxide regenerative fuel cells, that also allow reversed operation, such that oxidized fuel can be reduced back to unoxidized fuel using electrical energy as an input.

### SUMMARY

According to various embodiments, a system includes a fuel cell system configured to generate electrical power and waste heat, and an absorption chiller operatively coupled to the fuel cell system. The absorption chiller is configured to provide cooling using the waste heat generated by the fuel cell system.

According to another embodiment, a method of providing power and cooling includes generating electrical power using a fuel cell system; providing a hot exhaust stream from the fuel cell system to an absorption chiller; and cooling a fluid in the absorption chiller using the hot exhaust stream from the fuel cell system.

### BRIEF DESCRIPTION OF THE DRAWINGS

The accompanying drawings, which are incorporated herein and constitute part of this specification, illustrate example embodiments of the invention, together with the general description given above and the detailed description given below.

FIG. 1 is a schematic block diagram illustrating an integrated fuel cell power and absorption chiller system according to various embodiments of the present disclosure.

FIG. 2A is a perspective view of an integrated fuel cell power and absorption chiller system according to various embodiments of the present disclosure.

FIG. 2B is a top view of the system of FIG. 2A.

FIG. 2C is a side view of the system of FIG. 2A.

FIG. 3 is a schematic block diagram illustrating components of a power module according to various embodiments of the present disclosure.

FIG. 4 is a schematic block diagram illustrating components of an absorption chiller according to various embodiments of the present disclosure.

FIG. 5A is a top view of an integrated fuel cell power and absorption chiller system according to another embodiment of the present disclosure.

FIG. 5B is a top view of an integrated fuel cell power and absorption chiller system according to another embodiment of the present disclosure.

FIG. 6 is a top view of an integrated fuel cell power and absorption chiller system according to another embodiment of the present disclosure.

FIG. 7A is a top view of an integrated fuel cell power and absorption chiller system according to another embodiment of the present disclosure.

FIG. 7B is a top view of an integrated fuel cell power and absorption chiller system according to another embodiment of the present disclosure

FIG. 8A is a top view of an integrated fuel cell power and absorption chiller system according to another embodiment of the present disclosure.

FIG. 8B is a top view of an integrated fuel cell power and absorption chiller system 30 according to another embodiment of the present disclosure.

FIG. 9 is a side cross-section view of a vertically-stacked integrated fuel cell power and absorption chiller system according to another embodiment of the present disclosure.

### DETAILED DESCRIPTION

The various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the invention or the claims.

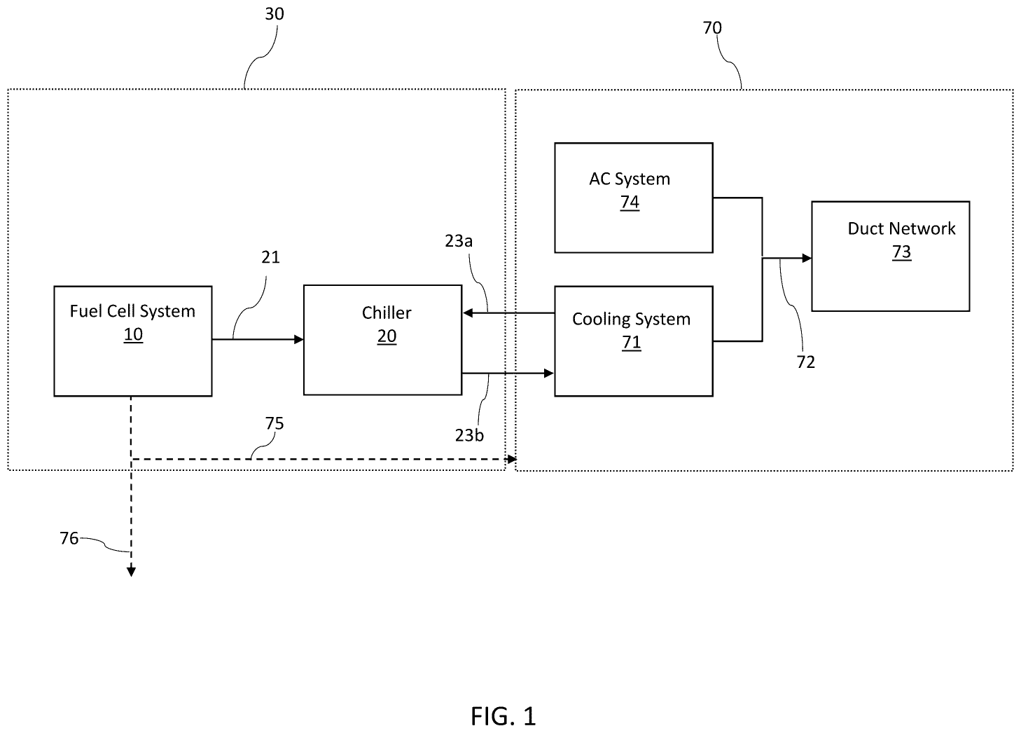

FIG. 1 is a schematic block diagram illustrating an integrated fuel cell power and absorption chiller system 30, according to various embodiments of the present disclosure. Referring to FIG. 1, the system 30 may include a fuel cell system 10 configured to generate electrical power, and an absorption chiller 20 operatively coupled to the fuel cell system 10 that is configured to provide cooling. In various embodiments, and as described in further detail below, the absorption chiller 20 may provide cooling using waste heat generated by the fuel cell system 10. The waste heat may be provided from the fuel cell system 10 through a conduit to the absorption chiller 20 in the form of an exhaust stream from the fuel cell system 10 through at least one conduit, as schematically indicated by arrow 21 in FIG. 1.

In various embodiments, the system 30 may be located at or near an end-user facility 70, which may include one or more of a residential structure, an office building, a factory, a retail store, an ocean vessel, a data center, or the like. In various embodiments, the system 30 may be installed adjacent to the end-user facility 70, inside the end-user facility 70, on a ground or basement floor of end-user facility 70, and/or on top of the end-user facility 70, such as in the case of a roof-mounted system 30. A cooling loop, indicated by arrows 23a and 23b in FIG. 1, may extend between the absorption chiller 20 of the system 30 and a cooling system 71 of the end-user facility 70. A cooling fluid, such as water, may flow from the cooling system 71 through a conduit (e.g., 23a) of the cooling loop into the absorption chiller 20, where the cooling fluid may be cooled by the absorption chiller 20 as described in further detail below. The cooled cooling fluid may then flow from the absorption chiller 20 through another conduit (e.g., 23b) of the cooling loop back to the cooling system 71 of the facility 70. The cooling system 71 may include a heat exchanger that may be used to transfer heat from air to the cooling fluid, thereby cooling the air and heating the cooling fluid. The cooling fluid may then return to the absorption chiller 20 to be cooled again. The cooled air may be provided through a conduit (shown by arrow 72) to a duct network 73 or other distribution system to provide the cooled air throughout all or a portion of the facility 70. The facility 70 may also optionally include a conventional air conditioning system 74 that may additionally be fluidly connected to the duct network 73, and which may be used to provide additional cooling as needed.

The fuel cell system 10 may be configured to generate electrical power, as described in further detail below. All or a portion of the power generated by the fuel cell system 10 may be provided for use by the end-user facility 70, as schematically illustrated by dashed arrow 75. Alternatively, or in addition, some or all of the power generated by the fuel cell system 10 may be provided to one or more different locations, such as to a different facility, a backup storage device such as a battery, and/or to a utility grid, as schematically illustrated by dashed arrow 76.

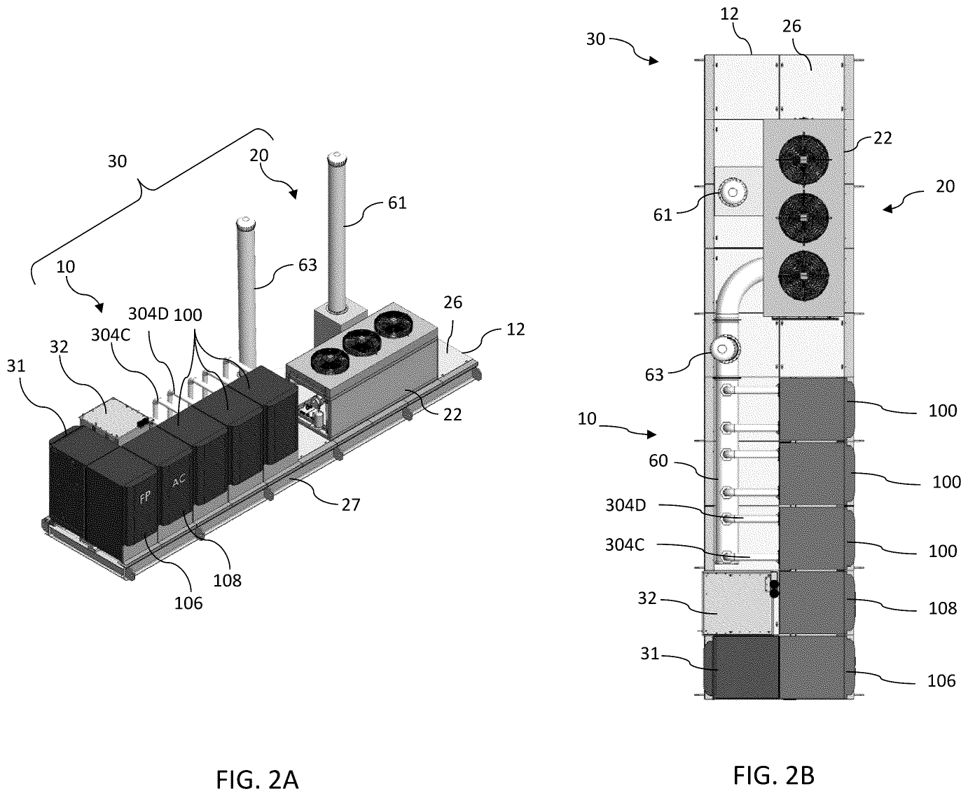

FIG. 2A is a perspective view of an exemplary integrated fuel cell power and absorption chiller system 30, according to various embodiments of the present disclosure. FIG. 2B is a top view of the system 30 of FIG. 2A. FIG. 2C is a back side view of the system 30 of FIG. 2A. Referring to FIGS. 2A-2C, the system 30 may include the fuel cell system 10 and the absorption chiller 20 located on a common base 12. In the embodiment of FIGS. 2A-2C, the common base 12 may include a skid, such as described in U.S. Patent Application Publication No. 2023/0282867 A1, the entire contents of which are incorporated by reference herein for all purposes. The skid 12 may include an upper surface, which may also be referred to as a deck 26, on which the fuel cell system 10 and the absorption chiller 20 may be supported. In some embodiments, the fuel cell system 10 may be located on a first side of the skid 12, and the absorption chiller 20 may be located on a second side of the skid 12 that is adjacent the first side. The deck 26 of the skid 12 may be supported above the installation surface (e.g., the ground, a floor, a roof, etc.) by a plurality of support elements 27 that may be connected to the deck 26. The support elements 27 may include a network of rail structures, such as metal (e.g., steel) rails, for example steel I-beams, that may be connected together (e.g., via mechanical fasteners, such as bolts, and/or welded together) to provide a suitably strong support base. As shown in FIGS. 2A and 2C, the support elements 27 may extend around the periphery of the skid 12. Additional support elements 27 (not visible in FIGS. 2A-2C) may extend across the skid 12 beneath the deck 26. The skid 12 may additionally include space between the deck 26 and the installation surface that may be used for electrical and/or plumbing connections to and between the various components of the fuel cell system 10 and/or the absorption chiller 20. At least some of the support elements 27 of the skid 12 may include fork pockets (not shown in FIGS. 2A-2C) for the insertion of the prongs of a forklift for transport, installation and/or removal of the system 30. The skid 12 may additionally include lift points for a crane, such as lift hooks. In some embodiments, the system 30 may be transported to or from an installation site on a flatbed truck over standard roadways, on standard gauge railway cars and/or via shipping containers. The system 30 including the skid 12 may be fully factory assembled and tested prior to deployment to the installation site, which may enable relatively fast and inexpensive installations.

Other suitable configurations for the system 30 may be utilized. For example, the system 30 may be mounted on multiple skids 12. In one embodiment, the fuel cell system 10 may be located on a first skid 12, and the absorption chiller 20 may be located on a second skid 12. The skids 12 may abut one another, or may be separated from one another. In some embodiments, different portions of the fuel cell system 10 may be located on different skids 12. In some embodiments, the system 30 may include more than one absorption chiller 20, which may be located on the same skid 12 or on different skids 12. Similarly, the system 30 may include one or more additional fuel cell systems 10, which may be located on additional skids 12.

Other suitable support bases 12 may be used to support all or a portion of the system 30 in addition to or instead of the skid. For example, all or a portion of the system 30 may be supported on a pad formed of suitable structural material(s), such as concrete.

Referring again to FIGS. 2A-2C, the fuel cell system 10 may include one or more power modules 100, fuel processing modules 106, and power conditioning (e.g., electrical output) modules 108, which may be disposed on the base 12. Each of the modules 100, 106, 108 may include its own housing or cabinet that is accessible by a door. For example, the power modules 100 may be fluidly connected with the fuel processing modules 106 through fluid conduits (e.g., pipes) that may be provided on, in, and/or below the base 12, and the power conditioning module 108 may be electrically connected to the power modules 100 through wires and/or cables provided on, in, and/or below the base 12.

The fuel processing module 106 may include components used for pre-processing a fuel, such as, for example, adsorption beds (e.g., desulfurizer and/or other impurity adsorption beds). The fuel processing module 106 may be configured to process different types of fuels. For example, the fuel processing module 106 may include at least one of a diesel fuel processing module, a natural gas fuel processing module, a hydrogen gas fuel processing module, or an ethanol fuel processing module in the same cabinet or in separate cabinets. A different bed composition tailored for a particular fuel may be provided in each fuel processing module 106. The fuel processing module 106 may process at least one of the following fuels: natural gas provided from a pipeline, compressed natural gas, methane, propane, liquid petroleum gas, gasoline, diesel, home heating oil, kerosene, JP-5, JP-8, aviation fuel, hydrogen, ammonia, ethanol, methanol, syn-gas, biogas, biodiesel and other suitable hydrocarbon or hydrogen containing fuels (e.g., pure hydrogen or ammonia). In some examples, a reformer may be included in the fuel processing module 106.

The power conditioning module 108 may include components for converting DC power generated by a fuel cell stack included in the power module 100 to AC power (e.g., at least one DC/AC inverter and optionally DC/DC converters described in U.S. Pat. No. 7,705,490, issued Apr. 27, 2010, the content of which is expressly incorporated herein by reference in its entirety), electrical connectors for AC power output to a power grid, circuits for managing electrical transients, and a system controller (e.g., a computer or dedicated control logic device or circuit). The power conditioning module 108 may be configured to convert DC power from the fuel cell modules to different AC voltages and frequencies. Components for 208V, 60 Hz; 480V, 60 Hz; 415V, 50 Hz and other common voltages and frequencies may be provided. The power conditioning module 108 may be electrically connected with the one or more power modules 100, e.g., via wires provided on, in and/or below the base 12, to provide power to the power modules 100 and receive power generated by the power modules 100.

In some embodiments, the functions of the fuel processing module and the power conditioning module may be combined in a single module, such that the above-described fuel processing and power conditioning components may be located in a single cabinet or housing.

While three power modules 100 are shown in FIGS. 2A-2C, the fuel cell system 10 may include any number of power modules 100. The power modules 100 may be arranged in a row as shown in FIGS. 2A-2C. In other embodiments, the fuel cell system 10 may include multiple rows of power modules 100. For example, the fuel cell system 10 may include two or more rows of power modules 100 stacked back to back, end to end, side by side, or on top of one another.

The fuel cell system 10 may also include additional ancillary equipment. The ancillary equipment may include one or more additional modules, such as a water distribution module (WDM) 31. The WDM 31 may include water treatment components (e.g., water deionizers) and water distribution pipes and valves which may be connected to a water supply (e.g., a municipal water supply pipe), and to the individual modules in the system 10.

The ancillary equipment of the fuel cell system 100 may also include an electrical distribution system (EDS) module 32. The EDS module 32 may control power distribution to various components located on and/or off of the skid 12. In some embodiments, the EDS module 32 may also include a disconnect component, such as a disconnect switchgear, that may be configured to protect, isolate and de-energize components of the fuel cell system 10 in the event of a fault condition and/or for maintenance purposes. In some embodiments, the disconnect component may be combined with or substituted with a backup power supply (BPS). In some embodiments, the EDS module 32 may include a telemetry component including system controllers and communication equipment that allows the fuel cell system 100 to communicate with a central controller and/or system operators. In some embodiments, one or more of the power distribution, disconnect and/or telemetry components of the EDS module 32 may be located in a separate module. It will be understood that other suitable ancillary equipment may be included in the fuel cell system 10 and/or co-located with the fuel cell system 10. For instance, a solid oxide electrolyzer system (not illustrated) may be co-located with the fuel cell system 10, as described in U.S. Pat. No. 11,820,247, the contents of which are incorporated by reference herein.

As shown in FIGS. 2B and 2C, the fuel cell system 10 may include an exhaust manifold 60 (e.g., a relatively wide conduit) configured to provide a system exhaust (e.g., anode tail gas oxidizer exhaust, which may also be referred to as a cathode or air exhaust) output from the power modules 100 to the absorption chiller 20. In particular, the exhaust manifold 60 may be fluidly connected to the power modules 100 by exhaust conduits 304C, 304D, as described in more detail below. The exhaust manifold 60 may direct the exhaust stream from the power modules 100 into a main housing 22 of the absorption chiller 20. The exhaust stream may pass through the main housing 22 of the absorption chiller 20 and may exit the system 30 via an exhaust vent stack 61. An induced draft fan 62 (see FIG. 2C) may be utilized to draw the exhaust stream from the main housing 22 of the absorption chiller 20 into the exhaust vent stack 61. The system 30 may also include a bypass vent stack 63 fluidly connected to the exhaust manifold 60 that may be used to vent all or a portion of the exhaust stream from the system 30 prior to the exhaust stream reaching the absorption chiller 20. A bypass damper 64 (see FIG. 2C) may be used to control the amount of the exhaust stream that is sent to the adsorption chiller 20 versus the amount that is discharged from the system 30 via the bypass vent stack 63. The bypass damper 64 may be located in the exhaust manifold 60.

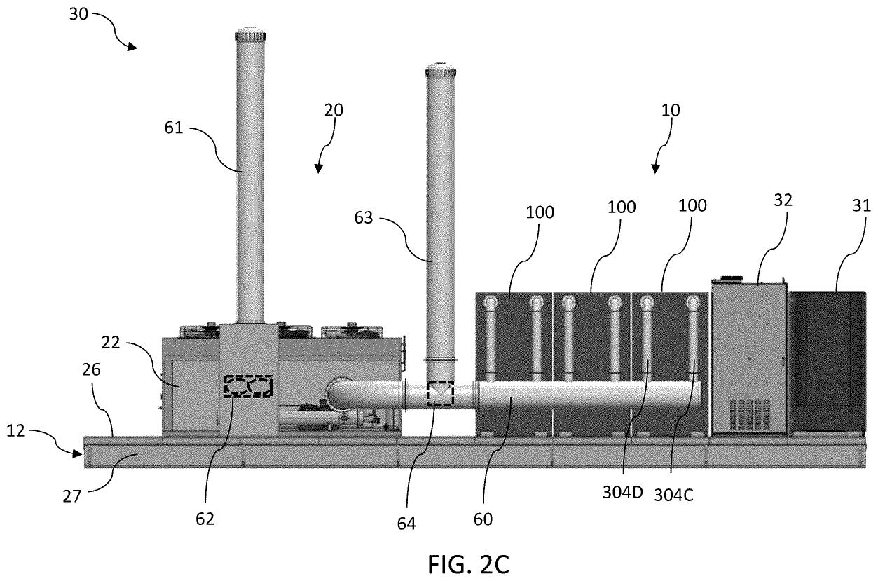

FIG. 3 is a schematic block diagram illustrating components of a power module 100 according to various embodiments of the present disclosure. Referring to FIG. 3, each power module 100 may include a module cabinet 40 containing a hotbox 50 and various components (e.g., balance of plant components) disposed in the cabinet 40 or adjacent thereto. The hotbox 50 may contain at least one fuel cell stack 102, such as a solid oxide fuel cell stack containing alternating fuel cells and interconnects. One solid oxide fuel cell of the stack contains a ceramic electrolyte, such as yttria stabilized zirconia (YSZ), scandia stabilized zirconia (SSZ), scandia and ceria stabilized zirconia or scandia, or yttria and ceria stabilized zirconia, an anode electrode, such as a nickel-YSZ, a nickel-SSZ or nickel-doped ceria cermet, and a cathode electrode, such as lanthanum strontium manganite (LSM). The interconnects may be metal alloy interconnects, such as chromium-iron alloy interconnects. The stacks 102 may be arranged over each other in a column. Alternatively, a column may contain only one stack 102. Plural columns may be located in each hot box 50.

The hotbox 50 may also contain an anode recuperator heat exchanger 110, a cathode recuperator heat exchanger 120, an anode tail gas oxidizer (ATO) 130, an anode exhaust cooler 140, an optional splitter 170, and a water injector 160. The power module 100 may also include an anode recycle blower 112. a CPOx blower 114 (e.g., CPOx air blower), a system blower 116 (e.g., main air blower), a catalytic partial oxidation (CPOx) reactor 118 and a mixer 120, which may all be disposed in the cabinet 40 outside of the hotbox 50. However, the present disclosure is not limited to any particular location for each of the components with respect to the hotbox 50.

The power module 100 may include an air conduit assembly 302 comprising air conduits 302A, 302B, and 302C that fluidly connect the system blower 116, the anode exhaust cooler 140, the cathode recuperator 120, and the stack 102. The power module 100 may also include an exhaust conduit assembly 304 comprising exhaust conduits 304A, 304B, 304C, and 304D that fluidly connect the stack 102, the ATO 130, the cathode recuperator 120, and the exhaust manifold 60.

The CPOx reactor 118 may receive a fuel inlet stream from a fuel inlet 190, through fuel conduit 300A. The fuel inlet 190 may be a fuel tank or a utility natural gas line including a valve to control an amount of fuel provided to the CPOx reactor 118. The CPOx blower 114 may provide air to the CPOx reactor 118 during system start-up. The air from the CPOx blower is turned off during system steady-state operation. The fuel and/or air may be provided to the mixer 120 by fuel conduit 300B. Fuel flows from the mixer 120 to the anode recuperator 110 through fuel conduit 300C. The fuel is heated in the anode recuperator 110 by the fuel exhaust (anode exhaust from stack 102) and the fuel then flows from the anode recuperator 110 to the stack 102 through fuel conduit 300D.

The system blower 116 may be configured to provide an air stream (e.g., air inlet stream) to the anode exhaust cooler 140 through air conduit 302A. Air flows from the anode exhaust cooler 140 to the cathode recuperator 120 through air conduit 302B. The air is heated by the ATO exhaust in the cathode recuperator 120. The air flows from the cathode recuperator 120 to the stack 102 through air conduit 302C. The power module 100 may include a pressure sensor 340, such as a piezoresistive pressure sensor, configured to measure air pressure in air conduit 302A.

Anode exhaust (e.g., fuel exhaust) generated in the stack 102 is provided to the anode recuperator 110 through an anode exhaust conduit 308. The anode exhaust may contain unreacted fuel and may also be referred to herein as fuel exhaust. The anode exhaust may be provided from the anode recuperator 110 to the mixer 120 by a recycling conduit 310, which may include a first recycling conduit 310A and a second recycling conduit 310B. In particular, the first recycling conduit 310A may fluidly connect an outlet of the anode recuperator 110 to an inlet of the anode exhaust cooler 140. The second recycling conduit 310B may fluidly connect an outlet of the anode exhaust cooler 140 to an inlet of the mixer 120.

Water flows from a water source, such as a water tank or a water pipe, to the water injector 160 through a water conduit 306. Water treatment processes may be applied to water supplied to water conduit 306 to remove impurities before supplying the water to the power module 100. The water injector 160 may be configured to inject water into anode exhaust flowing through the first recycling conduit 310A. Heat from the anode exhaust (also referred to as a recycled anode exhaust stream) vaporizes the water to generate steam which humidifies the anode exhaust. The humidified anode exhaust is provided to the anode exhaust cooler 140. Heat from the anode exhaust provided to the anode exhaust cooler 140 may be transferred to the air inlet stream provided from the system blower 116 to the cathode recuperator 120. The cooled humidified anode exhaust may then be provided from the anode exhaust cooler 140 to the mixer 120 via the second recycling conduit 310B. The anode recycle blower 112 may be configured to move the anode exhaust though the second recycling conduit 310B.

The mixer 120 is configured to mix the humidified anode exhaust with fresh fuel (i.e., fuel inlet stream). This humidified fuel mixture may then be heated in the anode recuperator 110 by the anode exhaust, before being provided to the stack 102. The power module 100 may also include one or more fuel reforming catalysts located inside and/or downstream of the anode recuperator 110. The reforming catalyst(s) reform the humidified fuel mixture before it is provided to the stack 102.

The splitter 170 may be operatively connected to the first recycling conduit 310A and may be configured to divert a portion of the anode exhaust to the ATO 130 via an ATO conduit 312A. The ATO conduit 312A may be fluidly connected directly to the ATO 130 or indirectly to the ATO 130 via the cathode exhaust conduit 304A.

Cathode exhaust (e.g., air exhaust) generated in the stack 102 is provided to the ATO 130 by the cathode exhaust conduit 304A. The cathode exhaust may be mixed with a portion of the anode exhaust before or after being provided to the ATO 130. The mixture of the anode exhaust and the cathode exhaust may be oxidized in the ATO 130. The oxidized cathode exhaust (i.e., ATO exhaust, which is also referred to as system exhaust) flows from the ATO 130 to the cathode recuperator 120, through cathode exhaust conduit 304B. Exhaust flows from the cathode recuperator 120 and out of the hotbox 50 through at least one exhaust outlet conduit, such as exhaust outlet conduits 304C and/or 304D. In one embodiment, the power module 100 may include two exhaust outlet conduits 304C, 304D in order to output the system exhaust (which in some embodiments may be referred to as cathode exhaust or ATO exhaust) from the hotbox 50 rather than a single larger outlet conduit due to system size constraints. However, the present disclosure is not limited to any particular number of outlet conduits, and a single outlet conduit may be used instead.

The exhaust outlet conduits 304C, 304D may be configured to provide the system exhaust to the exhaust manifold 60. The exhaust manifold 60 may provide the system exhaust to the absorption chiller 20, as described above. An optional bypass vent stack 63 (shown in FIGS. 2A-2C) may be configured to vent all or a portion of the exhaust to the atmosphere before it reaches the absorption chiller 20.

The power module 100 may further include a system controller 125 configured to control various elements of the power module 100. The controller 125 may include a central processing unit configured to execute stored instructions. For example, the controller 125 may be configured to control fuel and/or air flow through the power module 100, according to fuel composition data. The controller 125 may be configured to control the portion of the exhaust vented to the atmosphere through bypass vent stack 63, or, alternatively, coordinate through various communication signals with an integrated fuel cell and absorption chiller system controller (not shown) to control the amount of exhaust vented to the atmosphere through bypass vent stack 63.

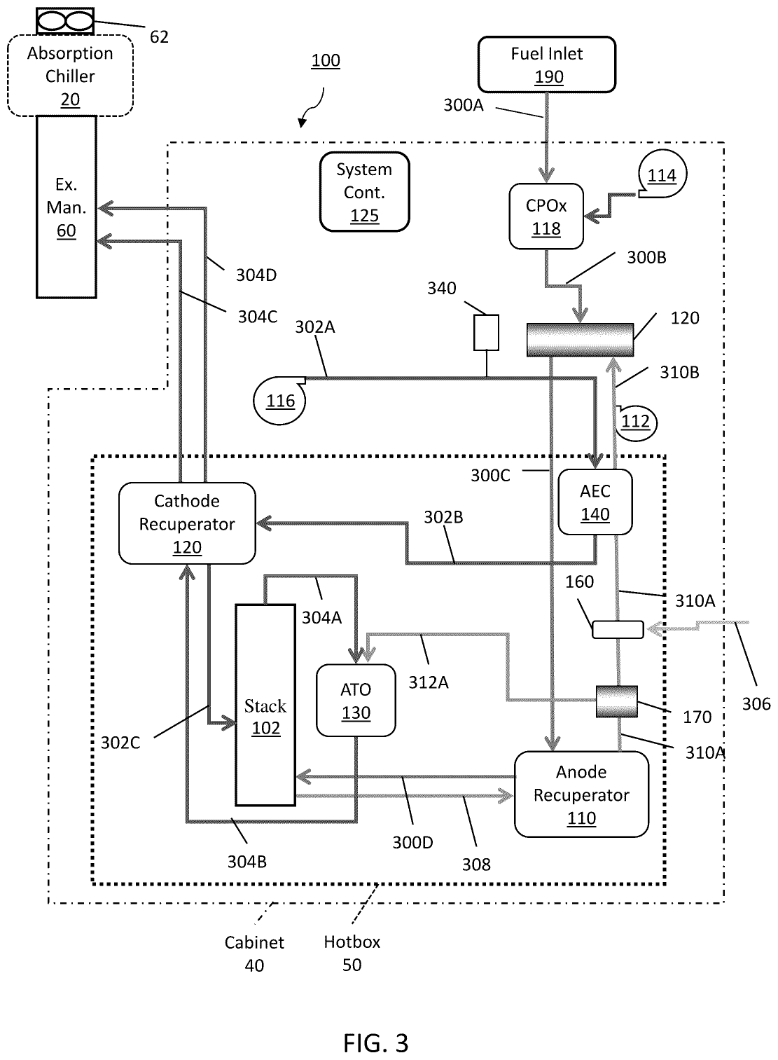

FIG. 4 is a schematic block diagram illustrating components of an absorption chiller 20 according to various embodiments of the present disclosure. An absorption chiller 20 is a type of chiller/refrigerant device that may utilize waste heat to drive thermodynamic processes that chill a cooling fluid (e.g., water), which is then distributed for HVAC or other cooling purposes. The absorption chiller 20 may include a generator 401, a condenser 403, an evaporator 405, and an absorber 407, which may be located within a common housing, such as the main housing 22 shown in FIGS. 2A-2C. The generator 401 may be in fluid communication with the condenser 403, and the evaporator 405 may be in fluid communication with the absorber 407. The absorption chiller 20 may additionally include other components, such as a heat exchanger 409, one or more pumps 411, 412 and 413 and various conduits.

A hot exhaust stream 21 in the exhaust manifold 60 (and/or one or more other conduits) from the fuel cell system 10 may flow through the generator 401 within one or more chiller exhaust conduits 415. A cooling fluid 23 (e.g., water) from an above-described cooling system 71 of a facility 70 (see FIG. 1) may flow through the evaporator 405 within one or more cooling fluid conduits 417. A coolant (e.g., water) may be pumped by pump 412 between the absorber 407 and the condenser 403 in a cooling conduit loop 419, as shown in FIG. 4.

The absorption chiller 20 may operate by cycling a refrigerant mixture through the generator 401, the condenser 403, the evaporator 405, and the absorber 407. The refrigerant mixture may include a mixture of water and another substance, such as lithium bromide or ammonia. In one non-limiting example, the refrigerant mixture may include about 60-65% lithium bromide and about 35-40% water. However, it will be understood that other suitable compositions for the refrigerant mixture of the absorption chiller 20 are within the contemplated scope of the disclosure.

The refrigerant mixture 418 may partially fill the absorber 407 to form a reservoir 420 of the refrigerant mixture 418. The refrigerant mixture 418 may be pumped by pump 411 from the reservoir 420 through a refrigerant mixture conduit 418C and the heat exchanger 409 and may enter the generator 401. Within the generator 401, heat from the hot exhaust stream 21 flowing through the chiller exhaust conduit(s) 415 may cause the refrigerant mixture 418 to separate into its constituent components. That is, water may evaporate from the refrigerant mixture 418 to form water vapor 421. The remaining refrigerant 422, which may be mostly lithium bromide, may collect at the bottom of the generator 401. The separated water vapor 421 may enter the condenser 403, where it may be cooled by the cooling conduit loop 419 and may condense into liquid water 423 that may collect at the bottom of the condenser 403.

The liquid water 423 from the condenser 403 may then flow through the water conduit 423C to the evaporator 405. The evaporator 405 may be maintained at a significantly lower pressure than the generator 401 and the condenser 403. The liquid water 423 may enter the evaporator 405 via a fixed orifice tube or an expansion valve 423T. The sudden decrease in pressure may cause the liquid water 423 entering the evaporator 405 to rapidly cool, such that the water 423 within the evaporator 405 may be at a lower temperature than the cooling fluid 23 flowing into the evaporator 405 through the cooling fluid conduit(s) 417. Thermal energy may therefore be transferred through the wall(s) of the cooling fluid conduit(s) 417 from the cooling fluid 23 to the water 423, thereby cooling (i.e., “chilling”) the cooling fluid 23. The “chilled” cooling fluid 23 may then be recirculated back to the cooling system 71 of the facility 70 to provide cooling as described above. The transfer of thermal energy from the cooling fluid 23 to the water 423 in the evaporator 405 may cause a portion of the water 423 in the evaporator 405 to boil and become water vapor 424. Water 423 that collects at the bottom of the evaporator 405 may be recirculated to the fixed orifice tube or an expansion valve 423T over the cooling fluid conduit(s) 417 via a pump 413 to provide further chilling of the cooling fluid 23 and evaporation of the water 423.

The lithium bromide-rich refrigerant 422 from the generator 401 may flow through refrigerant conduit 422C and the heat exchanger 409, where it may be cooled by the refrigerant mixture that is pumped from the absorber 407 to the generator 401. The lithium bromide-rich refrigerant 422 may then be injected (e.g., sprayed) into the absorber 407. Water vapor 424 from the evaporator 405 may also enter the absorber 407, where the water vapor 424 may be quickly absorbed with the lithium bromide-rich refrigerant 422 due to the strong affinity between the water vapor 424 and the lithium bromide-rich refrigerant 422. The water vapor 424 absorbed with the lithium bromide-rich refrigerant 422 may then be collected at the bottom of the absorber 407, thereby replenishing the refrigerant mixture in the reservoir 420 of the absorber 407. The coolant pumped through the cooling conduit loop 419 may remove additional heat from the refrigerant mixture in the absorber 407. The refrigerant mixture 418 in the reservoir 420 of the absorber 407 may then be pumped to the generator 401 to repeat the cycle.

The above discussion describes one example of the structure and operation of an absorption chiller 20 that may be utilized in an integrated fuel cell and absorption chiller system 30 according to various embodiments. However, it will be understood that various alternatives to the absorption chiller 20 shown in FIG. 4 may also be utilized. For example, although the absorption chiller 20 illustrated in FIG. 4 is a single-effect absorption chiller, a double-effect absorption chiller that may include a two-stage (e.g., high-temperature and low-temperature) generator may also be utilized.

Accordingly, in various embodiments, the waste heat from the exhaust stream 21 of the fuel cell system 10 may be utilized by the absorption chiller 20 to provide cooling for the facility 70, as shown in FIG. 1. An integrated fuel cell power and absorption chiller system 30 as shown in FIGS. 2A-2C may be configured to generate at least 50 kW, such as 100 to 200 kW of power. In one embodiment, 100 kW of power generation by the fuel cell system 10 may be used to produce 25 tons of refrigeration (TR) by the absorption chiller 20, which corresponds to approximately ˜300,000 BTU or 75,600 Kcal/hr of energy/heat load. One or more systems 30 as described above may be installed at the facility 70 to provide all or a portion of the cooling needs, and optionally the power needs, of the facility 70.

As discussed above with respect to FIG. 1, the system 30 according to various embodiments may be combined with a conventional air conditioning system 74 to provide cooling for the facility 70, which could be, for example, a retail facility, such as a supermarket or a “big box” retail store. In such facilities 70, the air conditioning units, which are often rooftop units, and/or the air handling units (AHUs), are typically operated with an “underdamped” response, meaning that the system will always reach the desired end state with some unavoidable inefficiencies due to “overshoot.” In various embodiments, the system 30 as described above may be paired with a conventional air conditioning system 74 and may be operated in an “always on” mode to provide a baseline level of cooling for the facility 70. This may permit the conventional air conditioning system to be operated with an “overdamped” response that may provide the desired end state to be reached while avoiding “overshoot.” This may provide improved efficiency for the cooling of the facility 70.

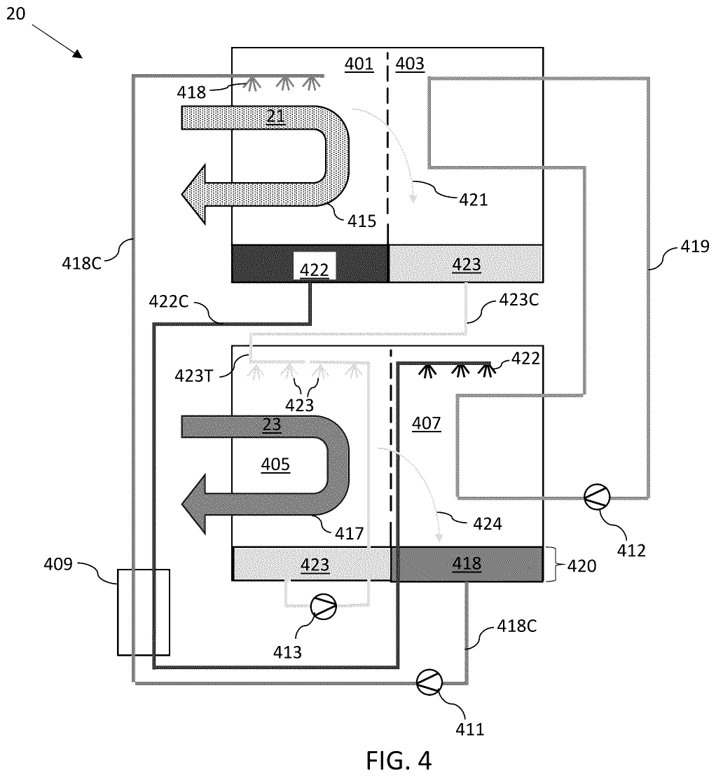

FIG. 5A is a top view of an integrated fuel cell power and absorption chiller system 30 according to another embodiment of the present disclosure. The system 30 of FIG. 5A may include the fuel cell power system 10 and the absorption chiller 20 as described above. The system 30 may be located on a suitable support, such as one or more above-described skids and/or on one or more pads. In the embodiment of FIG. 5A, the fuel cell power system 10 includes seven power modules 100, along with a fuel processing module 106, a power conditioning module 108, and a WDM 31. The fuel cell power system 10 may include two rows of modules arranged back-to-back, including a first row containing the fuel processing module 106, three power modules 100, and the WDM 31, and a second row containing the power conditioning module 108 and four power modules 100. An exhaust manifold 60 may be located in between and extending substantially parallel to the two rows of modules. Exhaust outlet conduits 304C, 304D may extend from the back sides of the power modules 100 to the exhaust manifold 60. The exhaust manifold 60 may couple the exhaust streams from the power modules 100 to the absorption chiller 20 as described above. An above-described bypass damper 64 and bypass vent stack 63 may be used to selectively vent all or a portion of the exhaust stream to the atmosphere prior to the exhaust stream reaching the absorption chiller 20.

FIG. 5B is a top view of an integrated fuel cell power and absorption chiller system 30 according to another embodiment of the present disclosure. The system 30 of FIG. 5B may have an alternative configuration compared to the system 30 of FIG. 5A. In the system 30 of FIG. 5B, the fuel processing module 106, the power conditioning module 108 and the power modules 100 may be arranged in a single row. The exhaust manifold 60 may extend substantially parallel to the row of modules along the back sides of the power modules 100 and may carry the exhaust streams from the power modules 100 to the absorption chiller 20. Exhaust outlet conduits 304C, 304D may extend from the back sides of the power modules 100 to the exhaust manifold 60. The system 30 shown in FIG. 5B does not include a WDM 31, although in other embodiments, the system 30 as shown in FIG. 5B may include a WDM 31 and/or other ancillary equipment as described above.

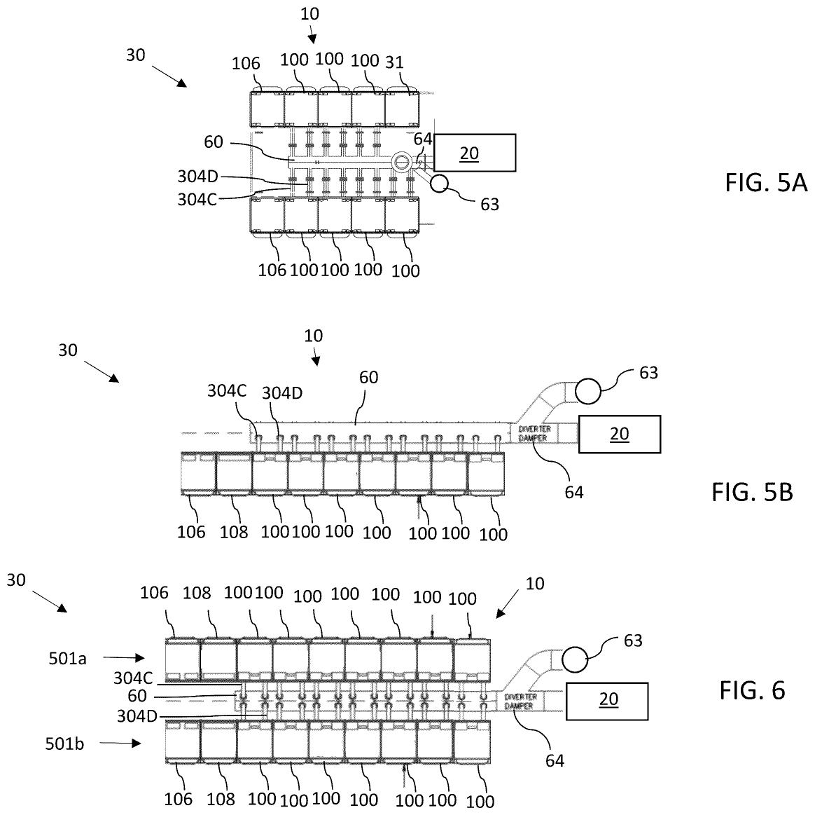

FIG. 6 is a top view of an integrated fuel cell power and absorption chiller system 30 according to another embodiment of the present disclosure. The system 30 of FIG. 6 includes a fuel cell power system 10 that includes two groups 501a, 501b of modules. Each group 501a, 501b includes a fuel processing module 106, a power conditioning module 108, and seven power modules 100. The fuel cell power system 10 may additionally include other ancillary equipment, such as a WDM, as described above. The ancillary equipment may be included in each group 501a, 501b or may be shared between the groups 501a, 501b. The groups 501a, 501b of modules may be arranged in respective rows, with a common exhaust manifold 60 located between the rows. Exhaust outlet conduits 304C, 304D may extend from the back sides of the power modules 100 in each group 501a, 501b to the exhaust manifold 60. The exhaust manifold 60 may carry exhaust from the power modules 100 to the absorption chiller 20 as described above.

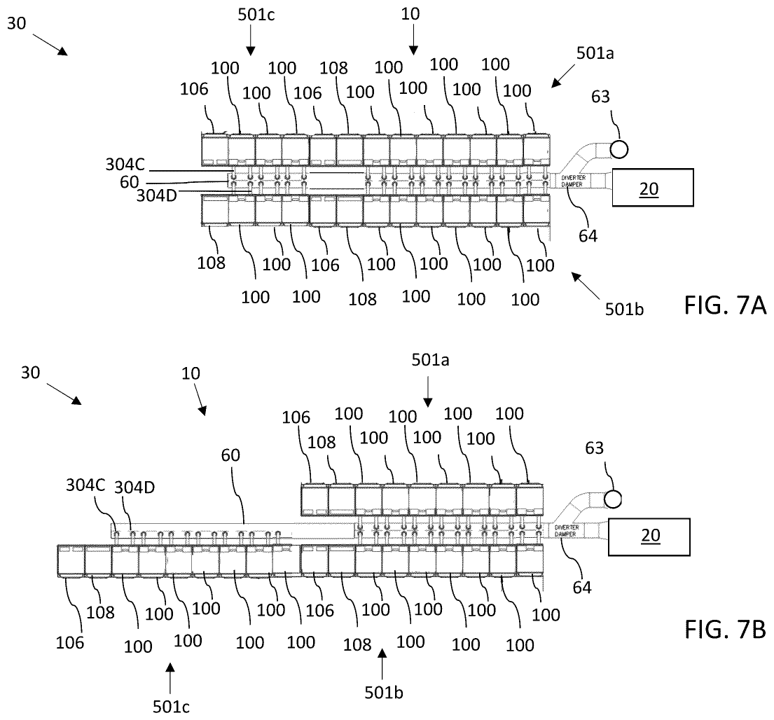

FIG. 7A is a top view of an integrated fuel cell power and absorption chiller system 30 according to another embodiment of the present disclosure. The system 30 of FIG. 7A includes a fuel cell power system 10 that includes three groups 501a, 501b and 501c of modules. The first group 501a and the second group 501b each include a fuel processing module 106, a power conditioning module 108, and seven power modules 100. The third group 501c includes a fuel processing module 106, a power conditioning module 108, and six power modules 100 The fuel cell power system 10 may additionally include other ancillary equipment, such as a WDM, as described above. The ancillary equipment may be included in each group 501a, 501b, 501c or may be shared between the groups 501a, 501b, 501c. The groups 501a, 501b, and 501c of modules may be arranged in two parallel rows, with a common exhaust manifold 60 located between the rows. A first row may include all of the modules of the first group 501a and a portion of the modules (e.g., the fuel processor module 106 and three power modules 100) of the third group 501c. The second row may include all of the modules of the second group 501b and the remaining modules (e.g., the power conditioning module 108 and three power modules 100) of the third group 501c. Exhaust outlet conduits 304C, 304D may extend from the back sides of the power modules 100 in each group 501a, 501b, 501c to the exhaust manifold 60. The exhaust manifold 60 may carry exhaust from the power modules 100 to the absorption chiller 20 as described above.

FIG. 7B is a top view of an integrated fuel cell power and absorption chiller system 30 according to another embodiment of the present disclosure. The system 30 of FIG. 7B is similar to the system 30 of FIG. 7A in that the fuel cell power system 10 that includes three groups 501a, 501b and 501c of modules. Each group 501a, 501b, and 501c includes a fuel processing module 106, a power conditioning module 108, and seven power modules 100. The fuel cell power system 10 may additionally include other ancillary equipment, such as a WDM, as described above. The ancillary equipment may be included in each group 501a, 501b, 501c or may be shared between the groups 501a, 501b, 501c. The groups 501a, 501b, and 501c of modules may be arranged in two parallel rows, with a common exhaust manifold 60 located between the rows. The modules of the first group 501a may be in a first row. The modules of the second group 501b and the modules of the third group 501b may extend adjacent to one another in the second row. Exhaust outlet conduits 304C, 304D may extend from the back sides of the power modules 100 in each group 501a, 501b, 501c to the exhaust manifold 60. The exhaust manifold 60 may carry exhaust from the power modules 100 to an absorption chiller 20 as described above.

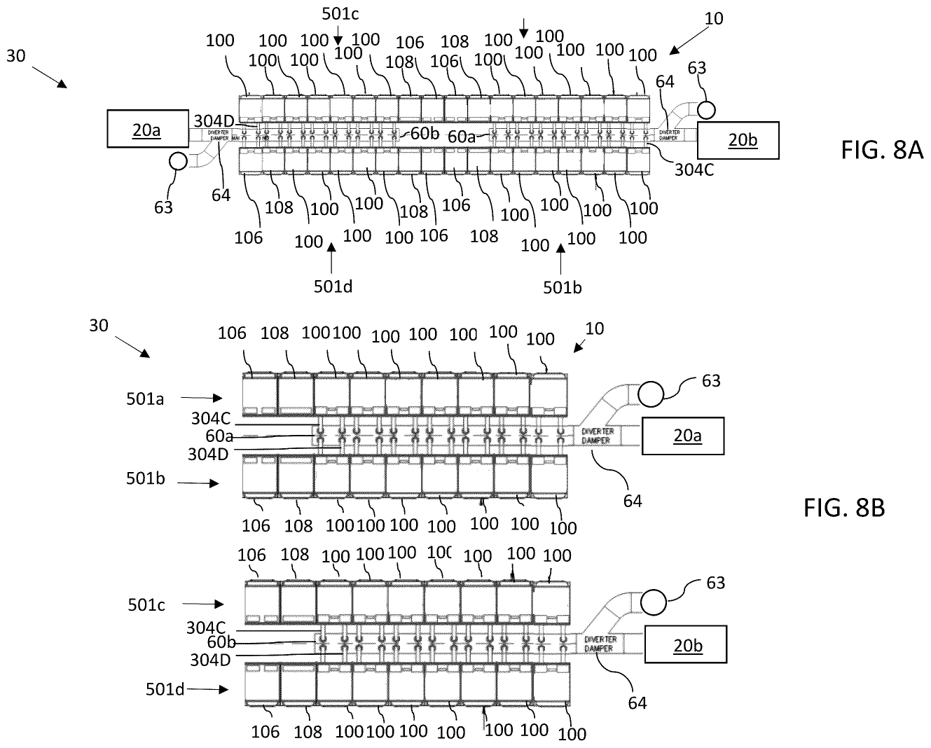

FIG. 8A is a top view of an integrated fuel cell power and absorption chiller system 30 according to another embodiment of the present disclosure. The system 30 of FIG. 8A includes a fuel cell power system 10 that includes four groups 501a, 501b, 501c and 501d of modules. The system 30 also includes two absorption chillers 20a and 20b. Each group 501a, 501b, 501c and 501d of modules of the fuel cell power system 10 includes a fuel processing module 106, a power conditioning module 108, and seven power modules 100. The fuel cell power system 10 may additionally include other ancillary equipment, such as a WDM, as described above. The ancillary equipment may be included in each group 501a, 501b, 501c, and 501d or may be shared between the groups 501a, 501b, 501c and 501d.

The groups 501a, 501b, 501c and 501d of modules of the fuel cell power system 10 may be arranged in two parallel rows. The absorption chillers 20a and 20b may be located on opposite ends of the pair of rows. A respective induced draft fan (element 62 shown in FIG. 2C) may be utilized to draw the exhaust stream from the main housing of the respective absorption chiller 20a and 20b into the exhaust vent stack of the respective absorption chiller 20a and 20b. A first row may include the modules of the first group 501a and the modules of the third group 501c extending adjacent to one another. The second row may include the modules of the second group 501b and the modules of the fourth group 501d extending adjacent to one another. In the embodiment shown in FIG. 8A, the fuel processing modules 106 and the power conditioning modules 108 of each group 501a, 501b, 501c and 501d of modules may be located in the center of the rows and the fuel cell power modules 100 may be located on either side of the fuel processing modules 106 and the power conditioning modules 108 within each row.

A first exhaust manifold 60a may be located between the first group 501a and the second group 501b of modules and may carry exhaust from the power modules 100 of the first group 501a and the second group 501b to a first absorption chiller 20a. A second exhaust manifold 60b may be located between the third group 501c and the fourth group 501d of modules and may carry exhaust from the power modules 100 of the third group 501c and the fourth group 501d to a second absorption chiller 20b. Exhaust outlet conduits 304C, 304D may extend from the back sides of the power modules 100 in each group 501a, 501b, 501c, and 501d to the respective exhaust manifolds 60a and 60b.

FIG. 8B is a top view of an integrated fuel cell power and absorption chiller system 30 according to another embodiment of the present disclosure. The system 30 shown in FIG. 8B may be similar to the system 30 of FIG. 8A in that the fuel cell power system 10 includes four groups 501a, 501b, 501c and 501d of modules and two absorption chillers 20a and 20b. Each group 501a, 501b, 501c and 501d of modules of the fuel cell power system 10 includes a fuel processing module 106, a power conditioning module 108, and seven power modules 100. The fuel cell power system 10 may additionally include other ancillary equipment, such as a WDM, as described above. The ancillary equipment may be included in each group 501a, 501b, 501c, and 501d or may be shared between the groups 501a, 501b, 501c and 501d.

The system 30 of FIG. 8B may differ from the system 30 of FIG. 8A in that each group 501a, 501b, 501c and 501d of modules may be arranged in a separate row of modules. A first exhaust manifold 60a may be located between the row of modules of the first group 501a and the row of modules of the second group 501b and may carry exhaust from the fuel cell power modules 100 of the first and second groups 501a and 501b to the first absorption chiller 20a. A second exhaust manifold 60b may be located between the row of modules of the third group 501c and the row of modules of the fourth group 501d and may carry exhaust from the fuel cell power modules 100 of the third and fourth groups 501a and 501b to the second absorption chiller 20b.

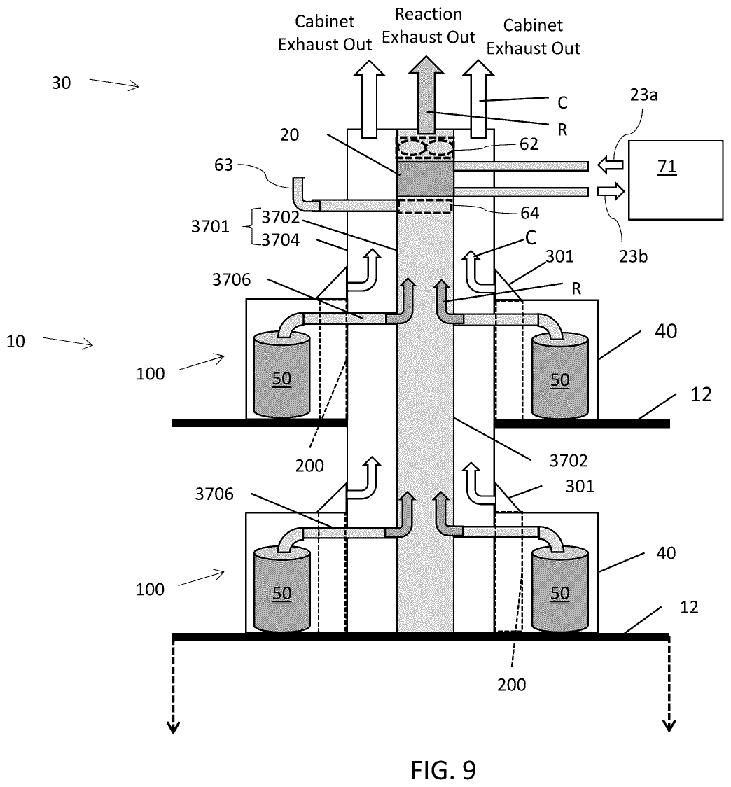

FIG. 9 is a side cross-section view of a vertically-stacked integrated fuel cell power and absorption chiller system 30 according to another embodiment of the present disclosure. Referring to FIG. 9, the system 30 may include a fuel cell power system 10 that includes a plurality of modules located on a plurality of supports 12. The supports 12 may be vertically spaced from one another such that the modules may have a vertically-stacked configuration. In some embodiments, the supports 12 may include the floors of a building. Alternatively, the supports 12 may be components of a separate support structure, such as a support tower, that may include a plurality of vertically-spaced supports 12 that are supported by support pillars (not shown in FIG. 9).

FIG. 9 illustrates a plurality of above-described power modules 100 located on the supports 12. It will be understood that the fuel cell power system 10 may also include additional modules, such as one or more fuel processing modules 106, one or more power conditioning modules 108, one or more WDMs 31, and the like. Each of the modules may include a cabinet 40. The power modules 100 may include a hot box 50 located inside of the cabinet 40. The hot box 50 may include fuel cells (e.g., fuel cell stacks, columns, and/or segments). The system 30 may also include an exhaust flue 3701 that is fluidly coupled to the power modules 100. The exhaust flue 3701 may include one or more inner ducts 3702 and at least one outer duct 3704. The inner duct 3702 may be configured to receive relatively hot reaction exhaust R from the hot box 50 of at least one of the power modules 100. The at least one outer duct 3704 may be configured to receive relatively cool cabinet exhaust C from the cabinet 40 of at least one of the power modules 100.

In some embodiments, the power modules 100 may include a ventilation module 200 attached to the back of the cabinet 40 of the power module 100. A ventilation duct 301 may fluidly connect each of the ventilation modules 200 to an outer duct 3704 of the exhaust flue 3701. For example, the outer duct 3704 may be fluidly connected to the ventilation modules 200 attached to the cabinets 22 by a ventilation duct 301. One or more transfer conduits 3706 may fluidly connect each of the hot boxes 50 of the power modules 100 to an inner duct 3702. In some embodiments, the flue 3701 may include a single outer duct 3704 that is configured to receive cabinet exhaust from all of the cabinets 40 and multiple inner ducts 3702 disposed in the single outer duct 3704. In other embodiments, the flue 3701 may include multiple outer ducts 3704 in which at least one inner duct 3702 is disposed. For example, four or more inner ducts 3702 may be disposed in each outer duct 3704.

In various embodiments, the system 30 may further include at least one absorption chiller 20 fluidly coupled to one or more inner ducts 3702 of the flue 3701. In some embodiments, the at least one absorption chiller 20 may be located above the power modules 100 at or near the top of the vertically-stacked system 30. For example, the absorption chiller 20 may be located on the roof of the facility (e.g., building) 70. The at least one absorption chiller 20 may be configured to receive hot reaction exhaust R from one or more inner ducts 3702. Cooling fluid may flow in a cooling loop 23a, 23b between the absorption chiller 20 and a cooling system 71 of the facility 70. The at least one absorption chiller 20 may utilize the hot reaction exhaust R to cool the cooling fluid in the cooling loop 23a, 23b as described above. Although a single absorption chiller 20 is shown in FIG. 9, it will be understood that the system 30 may include multiple absorption chillers 20, where each absorption chiller 20 may be fluidly coupled to at least one inner duct 3702 of the flue 3701. In some embodiments, the fan 62 may be used to draw the hot reaction exhaust R through the inner duct 3702 and the absorption chiller 20. The bypass damper 64 and bypass vent 63 may be optionally used to divert all or a portion of the hot reaction exhaust R from the absorption chiller 20.

Fuel cell systems of the embodiments of the present disclosure are designed to reduce greenhouse gas emissions and have a positive impact on the climate.

The preceding description of the disclosed aspects is provided to enable any person skilled in the art to make or use the present invention. Various modifications to these aspects will be readily apparent to those skilled in the art, and the generic principles defined herein may be applied to other aspects without departing from the scope of the invention. Thus, the present invention is not intended to be limited to the aspects shown herein but is to be accorded the widest scope consistent with the principles and novel features disclosed herein.

1. A system, comprising:
a fuel cell system configured to generate electrical power and waste heat, the fuel cell system comprising a plurality of power modules located on a common base, each of the plurality of power modules comprising a cabinet and a hotbox located within the cabinet, and each hot box contains at least one fuel cell stack; and
an absorption chiller operatively coupled to the fuel cell system, wherein the absorption chiller is configured to provide cooling using the waste heat generated by the fuel cell system and the fuel cell system and the absorption chiller are located on the common base.

2. The system of claim 1, wherein the waste heat is provided from the fuel cell system to the absorption chiller as an exhaust stream from the fuel cell system.

3. The system of claim 1, wherein the at least one fuel cell stack comprises a solid oxide fuel cell (SOFC) stack.

4. The system of claim 1, further comprising an exhaust manifold that fluidly couples the plurality of power modules to the absorption chiller, and a plurality of module exhaust conduits extending from the plurality of power modules to the exhaust manifold.

5. The system of claim 4, wherein the exhaust stream from the power modules is configured to flow through the exhaust manifold to the absorption chiller and then to flow through the absorption chiller via one or more chiller exhaust conduits.

6. The system of claim 5, further comprising:
a first vent stack that vents the exhaust stream after passing through the absorption chiller; and
a bypass damper configured to divert all or a portion of the exhaust stream from the exhaust manifold before it passes through the absorption chiller.

7. The system of claim 6, further comprising:
a second vent stack configured to vent the exhaust stream before it passes through the absorption chiller; and
a fan configured to draw the exhaust stream through the absorption chiller and out through the first vent stack.

8. The system of claim 5, wherein:
the absorption chiller further comprises one or more cooling fluid conduits that are configured to form a portion of a cooling loop extending between the absorption chiller and a cooling system of a facility; and
the one or more chiller exhaust conduits pass through a generator of the absorption chiller and the one or more cooling fluid conduits pass through an evaporator of the absorption chiller.

9. The system of claim 4, wherein:
the plurality of power modules are located within a row of modules;
the absorption chiller is located adjacent to an end of the row of modules; and
the exhaust manifold extends substantially parallel to the row of modules.

10. The system of claim 9, wherein the row of modules further comprises at least one of a power conditioning module, a fuel processing module, and a water distribution module.

11. The system of claim 9, wherein the fuel cell system comprises a pair of rows of modules extending substantially parallel to one another, each row of modules comprising the plurality of power modules, and the exhaust manifold extends between the rows of modules.

12. The system of claim 9, wherein:
the absorption chiller comprises a first absorption chiller located adjacent to a first end of the pair of rows of modules; and
the exhaust manifold comprises a first exhaust manifold extending between the rows of modules and configured to carry an exhaust stream from a first group of the plurality of power modules within the pair of rows of modules to the first absorption chiller.

13. The system of claim 12, further comprising:
a second absorption chiller located adjacent to a second end of the pair of rows of modules; and
a second exhaust manifold extending between the rows of modules and configured to carry an exhaust stream from a second group of power modules of the plurality of power modules within the pair of rows of modules to the second absorption chiller.

14. The system of claim 1, wherein the common base comprises a skid.

15. The system of claim 1, wherein the common base is located on a roof of a building.

16. A system comprising:
a fuel cell system configured to generate electrical power and waste heat, the fuel cell system comprising a plurality of power modules, each of the plurality of power modules comprising a cabinet and a hotbox located within the cabinet, and each hot box contains at least one fuel cell stack; and
an absorption chiller operatively coupled to the fuel cell system, wherein the absorption chiller is configured to provide cooling using the waste heat generated by the fuel cell system, wherein:
the system comprises a vertically-stacked system comprising a plurality of vertically-separated supports; and
the plurality power modules are located on the plurality of vertically-separated supports and are fluidly coupled to an exhaust flue configured to carry the exhaust stream from the plurality of power modules to the absorption chiller.

17. The system of claim 16, wherein the exhaust flue comprises an inner duct and an outer duct.

18. The system of claim 17, wherein:
the inner duct is configured to receive a relatively hot reaction exhaust from the hot boxes of the plurality of power modules;
the outer duct is configured to receive a relatively cool exhaust from the cabinets of the power modules; and
the absorption chiller is fluidly coupled to the inner duct.

19. A method of providing power and cooling, comprising:
generating electrical power using a fuel cell system;
providing a hot exhaust stream from the fuel cell system to an absorption chiller;
cooling a cooling fluid in the absorption chiller using the hot exhaust stream from the fuel cell system by circulating the cooling fluid between the absorption chiller and a cooling system of a facility, wherein the cooling fluid is chilled by the absorption chiller and absorbs heat from air to provide cooled air to the cooling system; and
providing the cooled air to a duct network to distribute the cooled air throughout all or a portion of the facility.

20. The method of claim 19, further comprising operating an air conditioning system of the facility with an overdamped response to provide additional cooling of the facility on an as-needed basis.
